(19) United States
(12) Patent Application Publication
(10) Pub. No.: US 2002/0011714 A1
(43) Pub. Date: Jan. 31, 2002

(54) Walker with a standing and suspension device

(76) Inventor: Mitsuhiro Kurashige, Hiroshima-shi (JP)

Correspondence Address: KODA & ANDROLIA, 2029 Century Park East, Suite 3850, Los Angeles, CA, 90067-3024, US

(21) Appl. No.: 09/785,754

(22) Filed: Feb. 16, 2001

(30) Foreign Application Priority Data
Jul. 25, 2000 (JP) 2000-223456

(51) Int. Cl. B62M 1/14

(52) U.S. Cl. 280/242.1

(57) ABSTRACT

A walker which allows walking under the user's own power, in which the overall height of the walker is greater than the height of the user's body, the user is lifted to his feet and held in a standing position by an extremely easy-to-use parachute harness when the user's body is suspended from a point above the user's head, and the height of the parachute harness is freely adjusted by the suspension device, so that the user can walk by causing his foot to contact the ground with an appropriate pressure.

### DETAILED DESCRIPTION OF THE INVENTION

1. Field of the Invention

The present invention relates to a walker that allows walking under the user's own power.

2. Prior Art

In the past, there have been walkers for the purpose of recovery of the walking function in adults. However, in most of these walkers, the user walks while supporting his body on the walker with both arms.

Persons who cannot support their bodies means, to put it concretely, persons who are paralyzed on the left (or right) side of the body, persons with spinal cord injury, muscular dystrophy, persons who feel the decline of muscular strength all over because of longtime bedridden live, and so on. For such persons who are paralyzed on the left (or right) side so that they cannot support their bodies in a standing position under their own power, training in walking using such walkers is virtually impossible. As a result, such persons remain bedridden and continue to suffer a weakening of the body. After this, as a typical example, persons who are paralyzed on the left (or right) side are taken for the explanation.

In another type of device, the user is trained in walking with his/her body suspended by a hoist. However, the walking range of such devices is limited, and the user cannot freely walk over a broad range.

In still another type of walker, the user can walk while the user's body is held by a harness. However, such walkers suffer from problems. Raising his/her body to a standing position prior to walking is conspicuously difficult for persons who are paralyzed on one side (on the left or right side) of the body.

### SUMMARY OF THE INVENTION

The present invention solves the above-described problems.

The object of the present invention is to provide a walker for persons who cannot support themselves with both of their arms or who cannot stand up by themselves, and the present invention allows walking under the user's own power, in which the overall height of the walker is set to be greater than the height of the user's body, the user is held in a standing position by an extremely easy-to-use parachute harness suspended by an overhead suspension device.

The user is lift to his feet slowly by the suspension device and then held in a standing position and given an appropriate pressure on his foot so that the user can walk (or can walk for the purpose of training).

In the above structure, the height of the parachute harness can be freely adjusted by the suspension device, so that the user can walk by causing his foot to contact the ground with an appropriate pressure.

Furthermore, the present invention provides a walker that allows walking under the user's own power, and in the walker of the present invention, a walker main body is higher than the body height of the user, a parachute harness is suspended via a suspension device from the upper part of the walker main body, and the height of the parachute harness is adjusted by the suspension device.

In the above structure, the suspension device is a winch or lever hoist and is operated manually or electrically.

### BRIEF DESCRIPTION OF THE DRAWINGS

FIG. 1 is a perspective view of one embodiment of the walker according to the present invention;

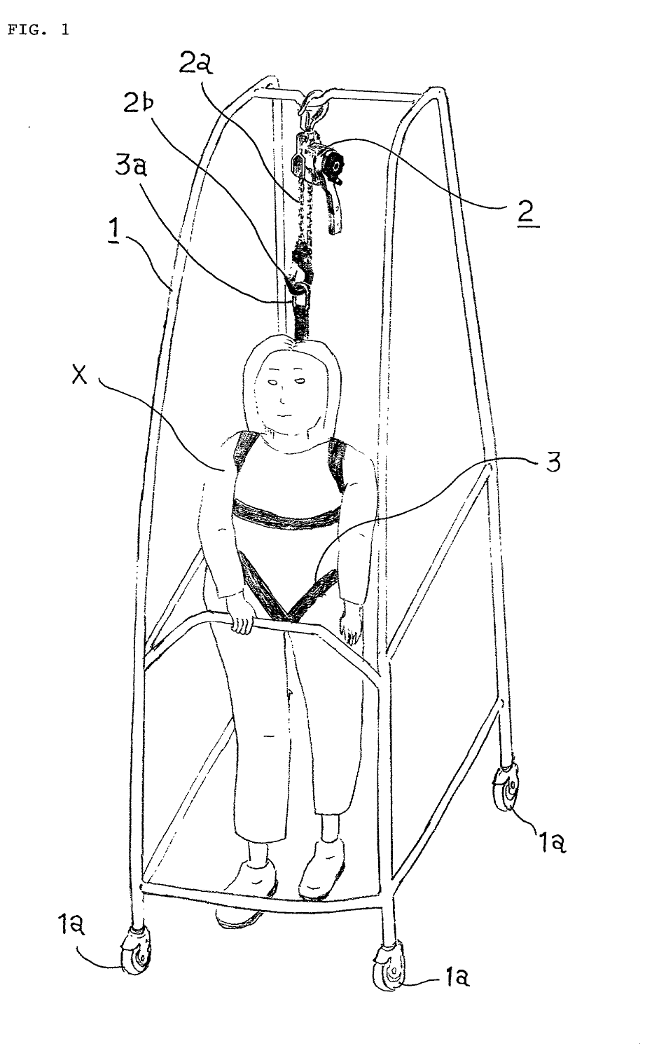

FIG. 2 is a perspective view of the suspension device used in the present invention; and

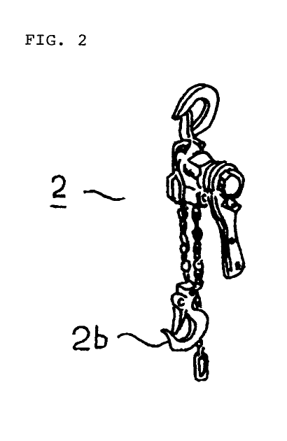

FIG. 3 is a perspective view of the parachute harness used in the present invention.

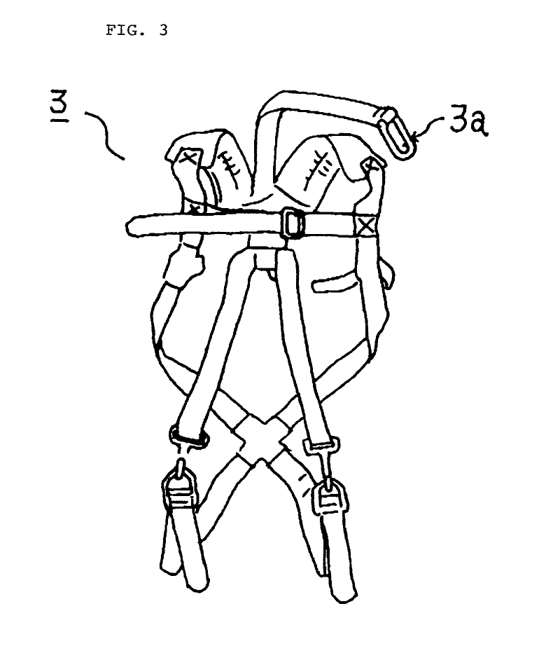

### DETAILED DESCRIPTION OF THE INVENTION

The preferred embodiment of the present invention will be described in detail with reference to the accompanying drawings.

The walker of the present invention that allows walking under the user's own power is characterized by the fact that a walker main body 1 is designed so as to be higher than the body height of the user, and a parachute harness 3 is suspended via a suspension device 2 from the upper part of the walker main body 1. The height of the parachute harness 3 is adjustable by the suspension device 2.

Casters 1 a are installed on the bottom parts of the walker main body 1 so that movement in all directions, i.e., front-back, left-right, etc., is possible. It is preferable that the casters I a are equipped with stoppers.

The height of the walker main body 1, that is a framework of, for instance, metal pipes, with an empty space inside, is set so that a parachute harness 3 is suspended via the suspension device 2 from a point that is higher than the body height of an adult. The center of gravity of the walker main body 1 is set to be high. Accordingly, it is necessary to form the walker main body 1 in a shape that has stability. For example, the lower half of the walker main body 1 is spread.

The suspension device 2 suspends the parachute harness 3 that is attached to the body X of a user, and the suspension device 2 adjusts the height of the parachute harness 3. Accordingly, the suspension device 2 is designed so as to be durable and easily operable. In concrete terms, a small winch or lever hoist is suitable for the suspension device 2. The suspension device 2 is operated manually or by an electrical device.

For the parachute harness 3, a harness of commercially marketed parachutes may be used. When the walker is to be used, the parachute harness 3 is attached to the body X of the user while the user is on the bed. The walker main body 1 is then moved to the vicinity of the bed, and the suspension device 2 is rotated in the reverse direction so that the chain 2a of the suspension device 2 is paid out. This chain 2a is extended over the bed, and a hook 2b provided at the tip end of the chain 2a is engaged with a suspension ring 3a of the parachute harness 3 while the parachute harness 3 is still on the bed.

Then, with the parachute harness 3 attached, the user is seated on the edge of the bed, and an assistant suspends the user from the walker main body 1 by causing forward rotation of the suspension device 2 either manually or electrically. The assistant then stops the take-up of the chain 2a of the suspension device 2 at an appropriate height.

The assistant provides support until the body X of the user is moved into the interior of the walker main body 1 and is held in a standing position. In this case, it is necessary that the stoppers be engaged with the casters 1 a of the walker main body 1 or that the assistant restrains the walker main body 1 so that the walker main body 1 does not move.

Then, when the user is in a standing position with his body suspended from the walker main body 1, the setting of the walker is completed. The user walks by treading on the floor surface with his usable foot so that the walker main body 1 is caused to move.

In this case, the vertical load that would be applied to both feet in the case of normal walking is dispersed among the casters 1 a and is converted into rolling resistance, so that the movement under the user's own power is possible even by means of an extremely small leg force. The load applied to both feet can be adjusted by means of the suspension device 2 (which is a winch, for instance), so that functional recovery of the paralyzed foot and maintenance of the healthy foot can be accomplished with an appropriate ground contact pressure.

The walker of the present invention can be used in another manner. After the user puts on the parachute harness 3 in bed, the user is temporarily transferred to a wheelchair and then enters the interior of the frame of the walker main body 1 together with the wheelchair. Thereafter, the suspension ring 3a of the parachute harness 3 is engaged with the hook 2b of the suspension device 2, the user is raised to an appropriate height by the suspension device 2, and the suspension device 2 is stopped.

Furthermore, it is possible with the walker of the present invention to recover the walking function of a person who is paralyzed on one side (left or right side) of the body. In such a case, the user wears a roller skate on one foot while the user is suspended from the walker main body 1. By this way, it is possible to accomplish walking training with the frictional force reduced.

As seen from the above, according to the present invention, since a parachute harness 3 is used, the body X of the user can be held in a standing position without applying an unreasonable burden by suspending the body using this parachute harness 3, even in cases where recovery of the walking function is extremely difficult, as in persons who are paralyzed on the left (or right) side of the body. Furthermore, even for persons who are naturally unable to support their own body weight under their own power, the vertical load is converted into rolling resistance by the casters. Thus, walking training can be accomplished relatively easily even with weakened leg force; and the possibility of re-acquiring of the walking function is heightened.

Furthermore, according to the present invention, walking training can be accomplished relatively easily by suspending the body X of the user from the walker main body 1 and adjusting the height by the suspension device 2. In addition, even when the user is walking while the user is suspended by the parachute harness 3, the user can try walking on his own feet. Thus, the desire to walk is heightened, resulting in an extremely high probability of recovering the walking function.

1. A walker that allows walking under the user's own power, comprising a walker main body that is higher than a body height of a user, and a parachute harness suspended via a suspension device from an upper part of said walker main body, a height of said parachute harness being adjusted by said suspension device.

2. The walker according to claim 1, wherein said suspension device is a winch that is manually operated.

3. The walker according to claim 1, wherein said suspension device is a winch that is electrically operated.

4. The walker according to claim 1, wherein said suspension device is a lever hoist that is manually operated.

5. The walker according to claim 1, wherein said suspension device is a lever hoist that is electrically operated.

6. A walker in which a user wearing a parachute harness is caused to stand and is maintained in a standing position by a winch from above a head of said user, so that a person who is paralyzed on one side is able to walk with one leg, thus allowing free walking.

7. A walker comprising:
a walker main body that is higher than a body height of a user and has an empty interior with casters provide at a bottom of said walker main body,
a suspension device installed at a top part of said walker main body so that a vertical length of said suspension device can be adjusted; and a
a parachute harness connected to a lower end of said suspension device so that said user wears said parachute harness and is suspended in said empty interior of said walker main body.
